(19) United States
(12) Patent Application Publication
(10) Pub. No.: US 2009/0098405 A1
(43) Pub. Date: Apr. 16, 2009

(54) BENT ROD-SHAPED METAL PARTICLES, MANUFACTURING METHOD FOR THE SAME, COMPOSITION CONTAINING THE SAME, AND CONDUCTIVE MATERIAL

(75) Inventor: Yuki MATSUNAMI, Ashigarakami-gun (JP)

Correspondence Address: BUCHANAN, INGERSOLL & ROONEY PC, POST OFFICE BOX 1404, ALEXANDRIA, VA, 22313-1404, US

(73) Assignee: FUJIFILM Corporation, Minato-ku (JP)

(21) Appl. No.: 12/246,141

(22) Filed: Oct. 6, 2008

(30) Foreign Application Priority Data
Oct. 12, 2007 (JP) 2007-266865

(51) Int. Cl. B29C 65/48

(52) U.S. Cl. 428/606; 156/296; 977/810

(57) ABSTRACT

To provide bent rod-shaped metal particles having at least one bend point, wherein an average bend angle at the bend point is 5° to 175°.

### BACKGROUND OF THE INVENTION

1. Field of the Invention

The present invention relates to bent-rod shaped metal particles, a manufacturing method for the same, a composition containing the same, and a conductive material containing the same.

2. Description of the Related Art

In recent years, metal nanowires have been studied as a conductive material that is transparent at visible wavelengths (400-800 nm). Metal nanowires are electrically conductive and thus can form a conductive layer when applied on a base (e.g., film), reducing the base's surface resistance. Moreover, they offer high optical transparency since their diameters are as small as 200 nm or less. For these reasons, there is an expectation that metal nanowires will replace indium tin oxide (ITO) for application as a transparent conductive film.

Japanese Patent Application Laid-Open (JP-A) Nos. 2004-196923 and 2005-317395 disclose compositions containing wire-shaped metal particles whose major axis, minor axis and aspect ratio are 400 nm or more, 50 nm or less and 20 or more, respectively, and also disclose that the compositions are used for electromagnetic wave-shielding filters, films and paints, conductive pastes, interconnection materials, electrode materials, and conductive films.

United States Patent Application Publication No. 2007/0074316 discloses a transparent conductive film containing silver nanowires with aspect ratios ranging from 10 to 1000,000 and diameters of not greater than 500 nm, wherein the transparent conductive film has an optical transmittance of 50% or more and surface resistance of 1.0×10⁶ Ω/sq. or less. Nano Lett., 2 (2002) pp. 165-168 discloses a method of preparation of linear metal nanowires by means of the polyol method.

The conductive layer in the conductive material is formed by applying onto a base surface a metal nanowire-containing composition. In the conductive film a conductive network is established by bonding together of metal nanowires. Thus, it is difficult for linear metal nanowires to form such a conductive network by being tangled with one another. In addition, the metal nanowires are generally covered with organic material such as dispersant for the purpose of preventing aggregation. The current situation is that the method of increasing conductivity is to facilitate bonding of metal nanowires by subjecting the nanowire-containing composition, applied onto a base surface, to annealing treatment or press treatment.

### BRIEF SUMMARY OF THE INVENTION

It is an object of the present invention to provide bent rod-shaped metal particles capable of producing a conductive material that offers high optical transmittance in the visible region and has excellent conductivity by virtue of its low surface resistance; a manufacturing method for the same; a composition containing the same; and a conductive material.

The inventor of the present application conducted extensive studies in order to solve the foregoing problems pertinent in the art, and established that, as represented in FIG. 1A that shows a transmission electron microscope (TEM) image and in FIG. 1B that shows a schematic illustration of the TEM image, a conductive network can be efficiently formed by using bent rod-shaped metal particles having at least one bend point for efficient formation of contact points among rod-shaped metal particles.

By way of example, two conductive layers containing the same amount of metal are prepared, one consisting of bent rod-shaped metal particles, and the other consisting of linear metal particles. In these conductive layers, bent rod-shaped metal particles shown in FIG. 2B were shown to be more tangled than linear metal particles shown in FIG. 2A, enabling more efficient formation of conductive network. It was also established that bent rod-shaped metal particles of the present invention inherently comprise contact points by which the surface resistance can be further reduced.

The present invention was accomplished based on the present inventor's findings described above, and means for solving the foregoing problems are as follows:

<1> Bent rod-shaped metal particles having at least one bend point, wherein an average bend angle at the bend point is 5° to 175°.

<2> The bent rod-shaped metal particles according to <1>, wherein the bend point is formed by bonding together of two rod-shaped metal particles at their ends.

<3> The bent rod-shaped metal particles according to <1>, wherein the bent rod-shaped metal particles have a minor-axis length of 1 nm to 500 nm and an aspect ratio, major-axis length/minor-axis length, of 10 or more.

<4> The bent rod-shaped metal particles according to <1>, wherein the bent rod-shaped metal particles are prepared by adding a metal compound and polyvinylpyrrolidone into a polyol compound-containing solvent to prepare a reaction solution, heating the solution at a temperature from 50° C. to the boiling point of the solvent, to effect reduction reaction for the formation of rod-shaped metal particles, and heating the reaction solution containing the rod-shaped metal particles at a temperature from 165° C. to the boiling point of the solvent.

<5> The bent rod-shaped metal particles according to <4>, wherein the polyol compound contains at least one compound selected from the group consisting of ethylene glycol, diethylene glycol, triethylene glycol, propylene glycol, glycerin, and polyethylene glycol.

<6> The bent rod-shaped metal particles according to <4>, wherein a metal in the metal compound contains at least one element selected from the group consisting of silver, gold, platinum, palladium, copper, nickel, and cobalt.

<7> The bent rod-shaped metal particles according to <4>, wherein the reaction solution contains chloride ions.

<8> The bent rod-shaped metal particles according to <4>, wherein the polyvinylpyrrolidone has two or more repeating pyrrolidone units.

<9> A method of manufacturing bent rod-shaped metal particles including:

adding a metal compound and polyvinylpyrrolidone into a polyol compound-containing solvent to prepare a reaction solution;

heating the solution at a temperature from 50° C. to the boiling point of the solvent, to effect reduction reaction for the formation of rod-shaped metal particles; and

heating the reaction solution containing the rod-shaped metal particles at a temperature from 165° C. to the boiling point of the solvent.

<10> A bent rod-shaped metal particle-containing composition including:

bent rod-shaped metal particles comprising at least one bend point, wherein an average bend angle at the bend point is 5° to 175°.

<11> A conductive material including:

a conductive layer formed of a bent rod-shaped metal particle-containing composition,

wherein the composition comprises bent rod-shaped metal particles comprising at least one bend point, wherein an average bend angle at the bend point is 5° to 175°.

<12> The conductive material according to <11>, wherein a surface resistance is 1×10⁵ Ω/sq. or less.

<13> The conductive material according to <11>, wherein an optical transmittance in the visible region is 50% or more.

The present invention can provide bent rod-shaped metal particles capable of solving the problems pertinent in the art, which bent rod-shaped metal particles are capable of producing a conductive material that offers high optical transmittance in the visible region and has excellent conductivity by virtue of its low surface resistance; a manufacturing method for the same; a composition containing the same; and a conductive material.

### BRIEF DESCRIPTION OF THE SEVERAL VIEWS OF THE DRAWINGS

FIG. 1A is a transmission electron scope (TEM) image of an example of bent rod-shaped metal particles of the present invention.

FIG. 1B is a schematic illustration of the TEM image of FIG. 1A.

FIG. 2A is a schematic illustration of linear metal particles contained in a conductive layer.

FIG. 2B is a schematic illustration of bent rod-shaped metal particles contained in a conductive layer.

FIG. 3A is an image of bent rod-shaped metal particles bonded together at their ends.

FIG. 3B is a schematic illustration of the image of FIG. 3A.

FIG. 4 is a TEM image of bent rod-shaped metal particles obtained in Example 1.

FIG. 5 is another TEM image of bent rod-shaped metal particles obtained in Example 1.

FIG. 6 is a TEM image of bent rod-shaped metal particles obtained in Example 3.

FIG. 7 is a TEM image of linear metal particles obtained in Comparative Example 1.

### DETAILED DESCRIPTION OF THE INVENTION

### Bent Rod-Shaped Metal Particles and Manufacturing Method for the Same

Bent rod-shaped metal particle according to an embodiment of the present invention have one or more bend points, wherein the average bend angle of the bend points is 5° to 175°.

A manufacturing method according to an embodiment of the present invention for manufacturing bent rod-shaped metal particles includes the steps of adding a metal compound and polyvinylpyrrolidone into a polyol compound-containing solvent to prepare a reaction solution, heating the solution at a temperature from 50° C. to the boiling point of the solvent, to effect reduction reaction for the formation of rod-shaped metal particles, and heating the reaction solution containing the rod-shaped metal particles at a temperature from 165° C. to the boiling point of the solvent.

Preferably, the bent rod-shaped metal particles of the present invention are manufactured by the manufacturing method of the present invention.

Through description of bent rod-shaped metal particles of the present invention, a manufacturing method of the present invention for manufacturing bend rod-shaped metal particles will also be described hereinafter.

Bent rod-shaped metal particles of the present invention have at least one bend point, preferably 1-10 bend points.

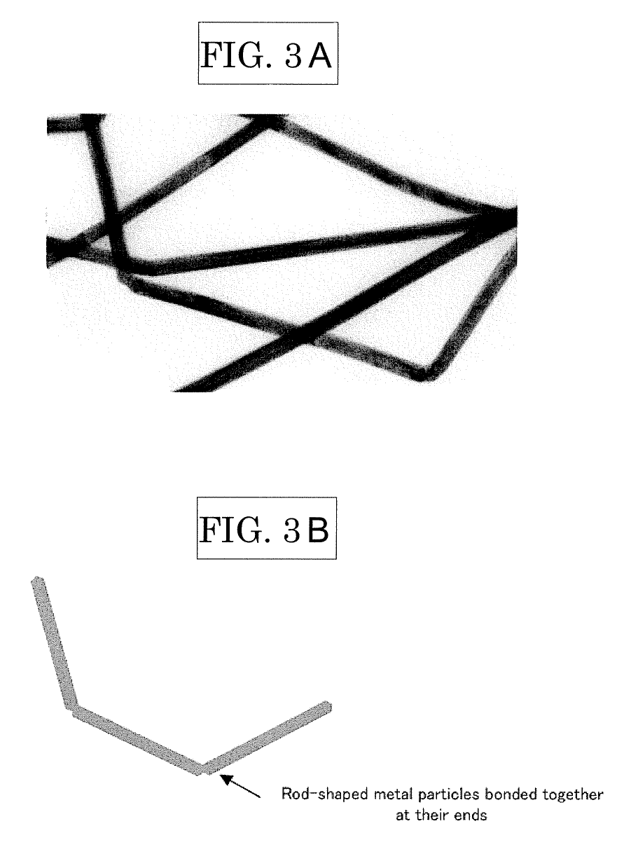

As shown in FIGS. 3A and 3B, the bend point is preferably formed by bonding together of two rod-shaped metal particles at their ends. Thus, even during preparation of a dispersion of bent rod-shaped metal particles or upon application of the dispersion onto a base, they never part from one another and never return to original discrete particles.

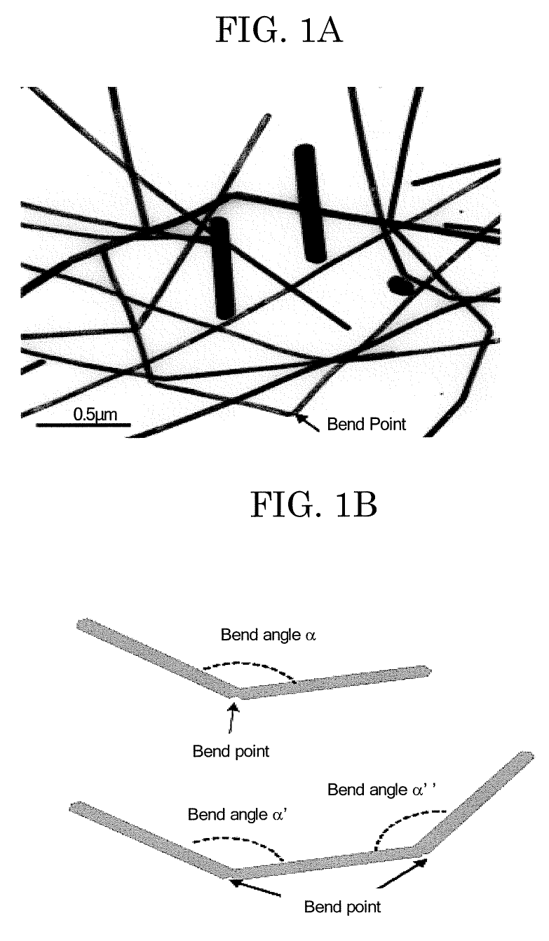

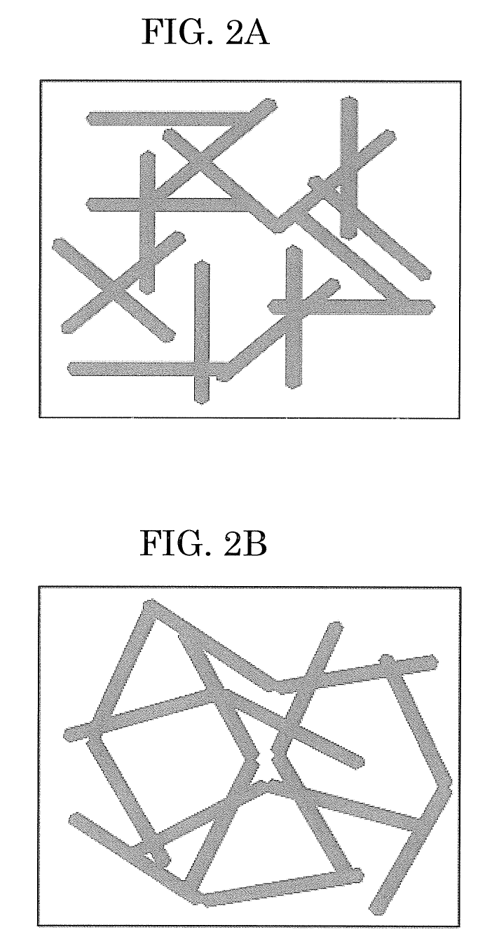

In FIG. 1B that shows a schematic illustration of the TEM image of FIG. 1A showing bent rod-shaped metal particles of the present invention, the bend angles at bend points are represented as α, α′, and α″. The average bend angle, an average value of the bend angles at the bend points, is 5° to 175°.

The average bend angle can be found by, for example, transmission electron microscopy (TEM) of bent rod-shaped metal particles.

The rod-shaped metal particles include wire-shaped and rod-shaped metal particles, with their minor-axis length preferably 1 nm to 500 nm, more preferably 5 nm to 200 nm, and their aspect ratio (major-axis length/minor-axis length) preferably 10 or more, more preferably 20 to 1,000.

The minor-axis lengths and aspect ratios can be calculated by measurement of the minor-axis lengths of bent rod-shaped metal particles by, for example, TEM, and by measurement of their major-axis length by, for example, scanning electron microscopy (SEM).

Preferably, bent rod-shaped metal particles of the present invention are manufactured by a method including the steps of adding a metal compound and polyvinylpyrrolidone into a polyol compound-containing solvent to prepare a reaction solution, heating the solution at a temperature from 50° C. to the boiling point of the solvent (first temperature), to effect reduction reaction for the formation of rod-shaped metal particles, and heating the reaction solution containing the rod-shaped metal particles at a temperature from 165° C. to the boiling point of the solvent (second temperature).

It is considered that heat treatment at the first temperature determines the end shapes of the rod-shaped particles and heat treatment at the second temperature causes rod-shaped particles to be bonded together at their ends to form bent rod-shaped particles. The bent angle between the particles is supposed to depend on their end shapes at the time when they are bonded together. If the second temperature is less than 165° C., the rod-shaped particles cannot be bonded at their ends, resulting in failure to obtain bent rod-shaped particles.

### —Solvent—

The solvent is selected from polyol compound-containing solvents, and optionally contains a solvent containing a compound other than polyol compounds. However, it is most preferable to employ a solvent containing only a polyol compound (100 vol. %).

The polyol compound is not specifically limited as long as it is selected from compounds having two or more hydroxyl groups, and can be appropriately selected according to the intended purpose. Examples thereof include, for example, ethylene glycol, diethylene glycol, triethylene glycol, propylene glycol, glycerin, and polyethylene glycol. These compounds may be used alone or in combination. Among them, ethylene glycol is most preferable.

The solvents other than the above polyol-containing solvents are not specifically limited and can be appropriately selected depending on the intended purpose. Examples thereof include, for example, N,N-dimethylformamide, propanol, ethanol, and methanol.

### —Metal Compounds—

Examples of the metal compound include, for example, metal salts, metal complexes, and organic metal compounds.

Examples of metals in the metal compound include, for example, silver, gold, platinum, palladium, copper, nickel and cobalt, with silver and gold being most preferable.

Acids that form the metal salts may be inorganic acids or organic acids. The inorganic acids are not specifically limited and can be appropriately selected according to the intended purpose. Examples thereof include, for example, oxalic acid, hydrochloric acid, and hydrohalic acids such as hydrobromic acid and hydroiodic acid. The organic acids are not specifically limited and can be appropriately selected according to the intended purpose. Examples thereof include, for example, carboxylic acids and sulfonic acids.

Examples of the carboxylic acids include, for example, acetic acid, lactic acid, oxalic acid, stearic acid, behenic acid, lauric acid and benzoic acid. Examples of the sulfonic acids include, for example, methyl sulfonic acid. Examples of the metal salts include, for example, silver nitrate, tetrachloroaurate and tetrachloroplatinate.

Chelating agents used for the formation of the metal complexes are not specifically limited and can be appropriately selected according to the intended purpose. Examples thereof include, for example, acetylacetonate and EDTA. The above metal salts may form complexes with ligands such as imidazole, pyridine, and phenylmethylsulfide.

The above metal compounds encompass halogenated complexes of metal ions (e.g., tetrachloroaurate and tetrachloroplatinate) and alkali metal salts (e.g., sodium tetrachloroaurate and sodium tetrachloropalladate).

### —Polyvinylpyrrolidone—

The above-noted polyvinylpyrrolidone (PVP) preferably has two or more repeating pyrrolidone units, more preferably 90 units or more. If the number of the repeating unit is less than 2, PVP mail fail to be adsorbed to specific crystal plane of metal particles, leading to formation of spherical particles. The molar ratio of polyvinylpyrrolidone (PVP) to the above-noted metal compound, (PVP/metal compound), is preferably 0.01 to 100, more preferably 0.1 to 20.

### —Chloride Ion—

The above-noted reaction solution preferably contains chloride ions such as those obtained from hydrochloric acid and sodium chloride.

A manufacturing method according to an embodiment of the present invention for manufacturing bent rod-shaped metal particles includes the steps of adding a metal compound and polyvinylpyrrolidone, and where necessary chloride ions, into a polyol-containing solvent to prepare a reaction solution, heating the solution at a temperature from 50° C. to the boiling point of the solvent, to effect reduction reaction for the formation of rod-shaped metal particles, and heating the reaction solution containing the rod-shaped metal particles at a temperature from 165° C. to the boiling point of the solvent for 1 minute to 120 minutes.

A heating temperature of less than 50° C. may result in prolonged reaction time.

### (Bent Rod-Shaped Metal Particle-Containing Composition)

A bent rod-shaped metal particle-containing composition according to an embodiment of the present invention contains bent rod-shaped metal particles and, where necessary, additional ingredient(s).

Examples of the additional ingredient include, for example, solvents and dispersants.

The solvent is not specifically limited and can be appropriately selected depending on the intended purpose; examples include, for example, water; alcohol solvents such as methanol, ethanol, n-propanol, isopropanol, t-butyl alcohol, glycerin, ethylene glycol, triethylene glycol, ethylene glycol monomethylether, diethylene glycol dimethylether, propylene glycol, dipropylene glycol, and 2-methyl-2,4-pentanediol; ketone solvents such as acetone, methyl ethyl ketone (MEK), methyl isobutyl ketone, cyclohexanone, cyclopentanone, 2-pyrrolidone, and N-methyl-2-pyrrolidone; ester solvents such as ethyl acetate and butyl acetate; amide solvents such as dimethylformamide and dimethylacetoamide; nitrile solvents such as acetonitrile and butyronitrile; ether solvents such as diethylether, dibutylether, tetrahydrofuran, and dioxane; halogenated hydrocarbons such as chloroform, dichloromethane, carbon tetrachloride, dichloroethane, tetrachloroethane, methylene chloride, trichloroethylene, tetrachloroethylene, chlorobenzene, and ortho-dichlorobenzene; phenols such as phenol, p-chlorophenol, o-chlorophenol, m-cresol, o-cresol, and p-cresol; aromatic hydrocarbons such as benzene, toluene, xylene, methoxybenzene, and 1,2-dimethoxybenzene; carbon bisulfide; ethyl cellosolve; and butyl cellosolve. These solvents may be used alone or in combination.

As described above, the bent rod-shaped metal particle-containing composition of the present invention contains bent rod-shaped metal particles of the present invention and therefore can find various applications; it is particularly suitable as a conductive material described below.

### (Conductive Material)

A conductive material according to an embodiment of the present invention includes at least a conductive layer formed of a bent rod-shaped metal particle-containing composition of the present invention, and includes a base, a undercoat layer and an overcoat layer, and where necessary, further includes additional layer(s).

### —Conductive Layer—

The conductive layer is formed of a bent rod-shaped metal particle-containing composition of the present invention, and can be formed by applying the composition onto a base.

Examples of the coating method are spin coating, casting, roll coating, flow coating, printing, dip coating, flow casting, bar coating, and gravure printing.

The thickness of the conductive layer is not specifically limited and can be appropriately set depending on the intended purpose; it is preferably 0.01 μm to 100 μm.

### —Base—

The shape, structure, size, etc., of the base are not specifically limited and can be appropriately set depending on the intended purpose. The base may be of flat shape, sheet shape, or film shape, for example. The base may have single layer structure or laminate structure.

Materials of the base are also not specifically limited; inorganic materials and organic materials can be suitably employed.

Examples of the inorganic materials include, for example, glass, quartz, and silicon. Examples of the organic materials include, for example, acetate resins such as triacetylcellulose (TAC), polyester resins such as polyethylene terephthalate (PET), polyethersulfone resins, polysulfone resins, polycarbonate resins, polyamide resins, polyimide resins, polyolefin resins, acrylic resins, polynorbornene resins, cellulose resins, polyarylate resins, polystyrene resins, polyvinyl alcohol resins, polyvinyl chloride resins, polyvinylidene chloride resins, and polyacrylic resins. These materials may be used alone or in combination.

The surface resistance of the conductive material is preferably 1.0×10⁵ Ω/sq. or less, more preferably 1.01/sq to 1.0×10⁴ Ω/sq.

The surface resistance can be measured by the four-probe method, for example.

The conductive material preferably has an optical transmittance of 50% or greater in the visible region (400-800 nm), more preferably 70% or greater.

The optical transmittance can be measured with a ultraviolet-visible spectrophotometer V-560 (JASCO Corporation), for example.

An conductive material of the present invention offers high optical transmittance in the visible region and has excellent conductivity by virtue of its low surface resistance, lending itself to applications such as conductive pastes, interconnection materials, electrode materials, conductive paints, conductive coats and conductive films, e.g., optical filters, catalysts, colorants, inkjet inks, color materials for color filters, cosmetics, near-infrared ray absorbers, anticounterfeit inks, electromagnetic wave-shielding films, surface-enhanced fluorescence sensors, surface-enhanced Raman scattering sensors, biological markers, recording materials, drug delivery carriers, biosensors, DNA chips, and test agents.

### EXAMPLES

Hereinafter, the present invention will be described with reference to Examples, which however shall not be construed as limiting the scope of the invention thereto.

### Example 1

### Preparation of Bent Rod-Shaped Silver Particles

Ethylene glycol (10 ml) was added in a three-necked flask equipped with a reflux tube. After purging the flask with nitrogen gas for 5 minutes, ethylene glycol was refluxed for 2 hours at 160° C. To the flask was added 3 ml of 0.1 mM tetrachloroaurate hexahydrate in ethylene glycol, heated at 160° C. for 5 minutes, and stirred. Additionally, 10 ml of an ethylene glycol solution containing 50 mM silver nitrate (Kanto Chemical Co., Ltd.) and 200 mM polyvinylpyrrolidone (weight−average molecular weight=360,000) was added to the reaction solution over 20 minutes. The reaction solution was heated at 160° C. for 60 minutes and stirred. After confirming the formation of rod-shaped silver particles, the solution was further heated at 180° C. for 60 minutes and stirred. The reaction solution was cooled to room temperature, and 5 volumes of acetone was added for aggregation of the resultant product. The aggregate was then dispersed in 10 ml of water to prepare a dispersion of bent rod-shaped silver particles.

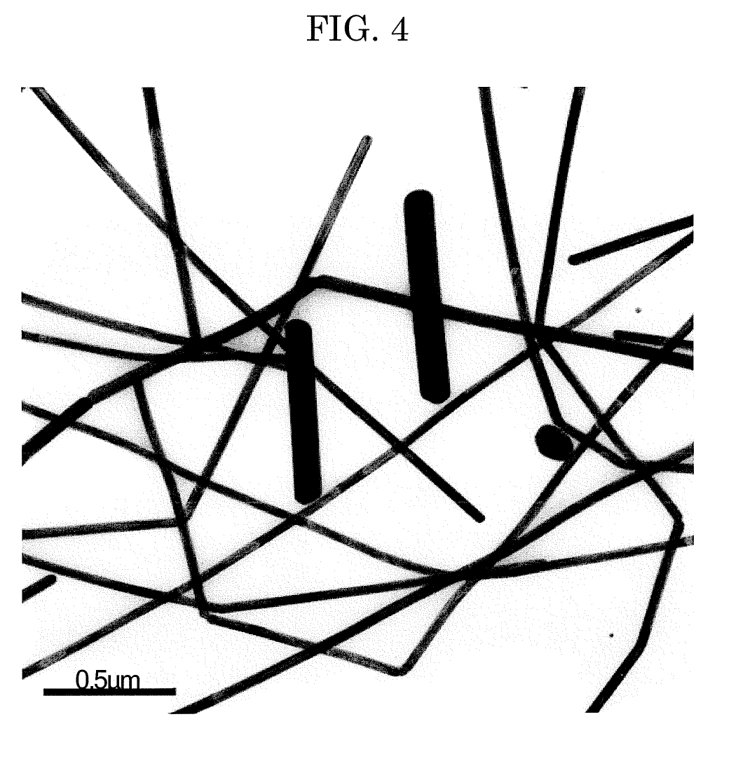

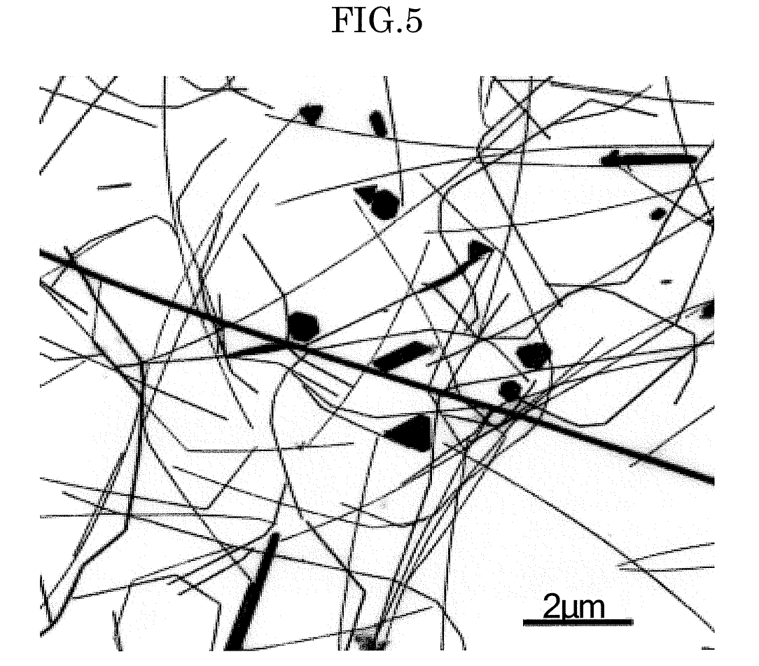

A drop of the dispersion was placed on the observation grid of a transmission electron scope (1200EX, JEOL Ltd.) and dried. Transmission electron microscopy of the dispersion demonstrated the predominant presence of bent rod-shaped silver particles formed by bonding together of linear silver particles at their ends, as shown in FIG. 4 (the scale bar in the drawing is 0.5 μm in length) and FIG. 5 (the scale bar in the drawing is 2 μm in length).

The average bend angle of the bend points, as measured by TEM, was 110°. The minor-axis length and aspect ratio of the bent rod-shaped silver particles, as measured by TEM, were 40 nm and 100, respectively.

### Example 2

### Fabrication of Conductive Film

A 1.5 wt % polyvinyl alcohol (PVA) aqueous solution was applied onto a 100 μm-thick polyethylene terephthalate (PET) base using a #10 coat bar, and dried at 60° C. for 5 minutes to form a undercoat layer.

The dispersion prepared in Example 1 (0.3 wt %) was then applied onto the PVA coat of the PET base using the #10 bar, and dried at 60° C. for 5 minutes to form is a bent rod-shaped silver particle-containing layer, which was then subjected to annealing treatment at 120° C. for 5 minutes to enhance conductivity.

Subsequently, 1.0 wt. % PVA in methyl ethyl ketone was applied onto the bent rod-shaped silver particle-containing layer of the PET base using the #10 bar, and dried at 60° C. for 5 minutes to form an overcoat layer. In this way a conductive film containing bent rod-shaped silver particles was fabricated.

The conductive film had a surface resistance of 10¹-10² Ω/sq. as measured by the four-probe method. The conductive film had an optical transmittance of not less than 82% in the visible region (400-800 nm) as measured with a ultraviolet-visible spectrophotometer V-560 (JASCO Corporation).

### Example 3

### Preparation of Bent Rod-Shaped Silver Particles

Bent rod-shaped silver particles of Example 3 were prepared as in Example 1 except that the reflow temperature, reaction temperature after addition of 3 ml of 0.1 mM tetrachloroaurate hexahydrate in ethylene glycol, and reaction temperature after addition of 10 ml of an ethylene glycol solution containing 50 mM silver nitrate (Kanto Chemical Co., Ltd.) and 200 mM polyvinylpyrrolidone (weight-average molecular weight=360,000) were all set to 180° C.

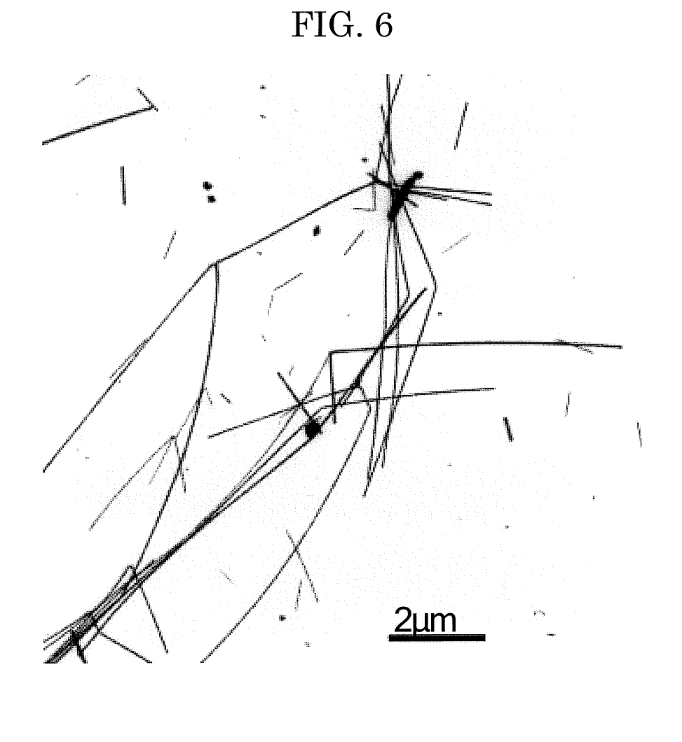

As in Example 1, transmission electron microscopy of the dispersion demonstrated the presence of bent rod-shaped silver particles formed by bonding together of linear silver particles at their ends, as shown in FIG. 6 (the scale bar in the drawing is 2 μm in length).

The average bend angle of the bend points, as measured by TEM, was 90°. The minor-axis length and aspect ratio of the bent rod-shaped silver particles, as measured by TEM, were 36 nm and 110 respectively.

### Example 4

### Fabrication of Conductive Film

A conductive film of Example 4 was fabricated as in Example 2 except that the dispersion of bent rod-shaped silver particles prepared in Example 3 was used instead of the dispersion of Example 1.

The conductive film had a surface resistance of 10′-10² Ω/sq. as measured as in Example 1. The conductive film had an optical transmittance of 83% in the visible region (400-800 nm) as measured as in Example 1.

### Comparative Example 1

### Preparation of Linear Silver Particles

Ethylene glycol (10 ml) was added in a three-necked flask equipped with a reflux tube. After purging the flask with nitrogen gas for 5 minutes, ethylene glycol was refluxed for 2 hours at 160° C. To the flask was added 3 ml of 0.1 mM tetrachloroaurate hexahydrate in ethylene glycol, heated at 160° C. for 5 minutes, and stirred. Additionally, 10 ml of an ethylene glycol solution containing 50 mM silver nitrate and 200 mM polyvinylpyrrolidone (weight-average molecular weight=360,000) was added to the reaction solution over 20 minutes. The reaction solution was heated at 160° C. for 60 minutes and stirred. After confirming the formation of linear silver particles, the solution was further heated at 160° C. for 60 minutes and stirred. The reaction solution was cooled to room temperature, and 5 volumes of acetone was added for aggregation of the resultant product. The aggregate was then dispersed in 10 ml of water to prepare a dispersion of linear silver particles.

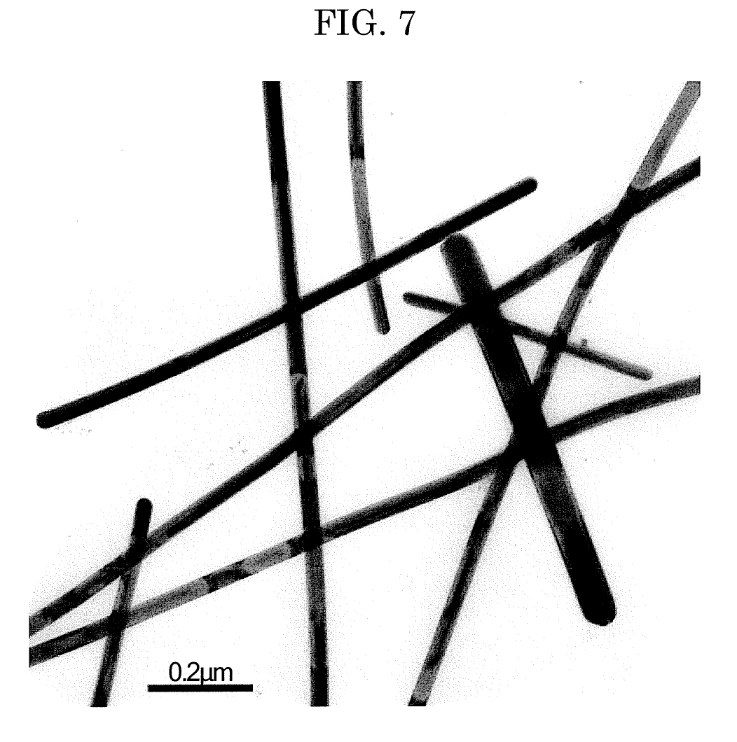

A drop of the dispersion was placed on the observation grid of a transmission electron scope (1200EX, JEOL Ltd.) and dried. Transmission electron microscopy of the dispersion demonstrated the predominant presence of linear silver particles which are free from branches, as shown in FIG. 7.

No bend points were observed by TEM. The minor-axis length and aspect ratio of the linear silver particles, as measured by TEM, were 40 nm and 100, respectively.

### Comparative Example 2

### Fabrication of Conductive Film

A conductive film of Comparative Example 2 was fabricated as in Example 2 except that the dispersion of linear silver particles prepared in Comparative Example 1 was used instead of the dispersion of Example 1.

The conductive film had a surface resistance of 10²-10³ Ω/sq. as measured by the four-probe method. The conductive film had an optical transmittance of not less than 85% in the visible region (400-800 nm) as measured with a ultraviolet-visible spectrophotometer V-560 (JASCO Corporation).

### Comparative Example 3

### Preparation of Linear Silver Particles

In accordance with the description of Chemical Physics Letters 380(1-2), 2003, pp. 146-149, additional experimentation was carried out as follows.

Ethylene glycol (10 ml) was added in a three-necked flask equipped with a reflux tube. After purging the flask with nitrogen gas for 5 minutes, ethylene glycol was refluxed for 2 hours at 160° C. To the flask was added 3 ml of 0.1 mM tetrachloroaurate hexahydrate in ethylene glycol, heated at 160° C. for 5 minutes, and stirred. Additionally, 10 ml of an ethylene glycol solution containing 50 mM silver nitrate and 200 mM polyvinylpyrrolidone (weight-average molecular weight 40,000) was added to the reaction solution over 20 minutes. The reaction solution was heated at 160° C. for 40 minutes and stirred. The reaction solution was cooled to room temperature, and 5 volumes of acetone was added for aggregation of the resultant product. The aggregate was then dispersed in 10 ml of water to prepare a dispersion of linear silver particles.

A drop of the dispersion was placed on the observation grid of a transmission electron scope (1200EX, JEOL, Ltd.) and dried. Transmission electron microscopy of the dispersion demonstrated the predominant presence of linear silver particles.

No bend points were observed by TEM. The minor-axis length and aspect ratio of the linear silver particles, as measured by TEM, were 250 nm and 30, respectively.

### Comparative Example 4

### Fabrication of Conductive Film

A conductive film of Comparative Example 4 was fabricated as in Example 2 except that the dispersion of linear silver particles prepared in Comparative Example 3 was used instead of the dispersion of Example 1.

The conductive film had a surface resistance of 10³-10⁴ Ω/sq. as measured by the four-probe method. The conductive film had an optical transmittance of not less than 85% in the visible region (400-800 nm) as measured with a ultraviolet-visible spectrophotometer V-560 (JASCO Corporation).

Bent rod-shaped metal particles of the present invention offer high optical transmittance in the visible region and has excellent conductivity by virtue of its low surface resistance, and therefore are suitably used for conductive pastes, interconnection materials, electrode materials, conductive paints, conductive coats and conductive films.

A conductive material of the present invention can be suitably used for, for example, optical filters, catalysts, colorants, inkjet inks, color materials for color filters, cosmetics, near-infrared ray absorbers, anticounterfeit inks, electromagnetic wave-shielding films, surface-enhanced fluorescence sensors, surface-enhanced Raman scattering sensors, biological markers, recording materials, drug delivery carriers, biosensors, DNA chips, and test agents.

What is claimed is:

1. Bent rod-shaped metal particles comprising at least one bend point, wherein an average bend angle at the bend point is 5° to 175°.

2. The bent rod-shaped metal particles according to claim 1, wherein the bend point is formed by bonding together of two rod-shaped metal particles at their ends.

3. The bent rod-shaped metal particles according to claim 1, wherein the bent rod-shaped metal particles have a minor-axis length of 1 nm to 500 nm and an aspect ratio, major-axis length/minor-axis length, of 10 or more.

4. The bent rod-shaped metal particles according to claim 1, wherein the bent rod-shaped metal particles are prepared by adding a metal compound and polyvinylpyrrolidone into a polyol compound-containing solvent to prepare a reaction solution, heating the solution at a temperature from 50° C. to the boiling point of the solvent, to effect reduction reaction for the formation of rod-shaped metal particles, and heating the reaction solution containing the rod-shaped metal particles at a temperature from 165° C. to the boiling point of the solvent.

5. The bent rod-shaped metal particles according to claim 4, wherein the polyol compound contains at least one compound selected from the group consisting of ethylene glycol, diethylene glycol, triethylene glycol, propylene glycol, glycerin, and polyethylene glycol.

6. The bent rod-shaped metal particles according to claim 4, wherein a metal in the metal compound contains at least one element selected from the group consisting of silver, gold, platinum, palladium, copper, nickel, and cobalt.

7. The bent rod-shaped metal particles according to claim 4, wherein the reaction solution contains chloride ions.

8. The bent rod-shaped metal particles according to claim 4, wherein the polyvinylpyrrolidone has two or more repeating pyrrolidone units.

9. A method of manufacturing bent rod-shaped metal particles comprising:
adding a metal compound and polyvinylpyrrolidone into a polyol compound-containing solvent to prepare a reaction solution;
heating the solution at a temperature from 50° C. to the boiling point of the solvent, to effect reduction reaction for the formation of rod-shaped metal particles; and
heating the reaction solution containing the rod-shaped metal particles at a temperature from 165° C. to the boiling point of the solvent.

10. A bent rod-shaped metal particle-containing composition comprising:
bent rod-shaped metal particles comprising at least one bend point, wherein an average bend angle at the bend point is 5° to 175°.

11. A conductive material comprising:
a conductive layer formed of a bent rod-shaped metal particle-containing composition,
wherein the composition comprises bent rod-shaped metal particles comprising at least one bend point, wherein an average bend angle at the bend point is 5° to 175°.

12. The conductive material according to claim 11, wherein a surface resistance is 1×10⁵ Ω/sq. or less.

13. The conductive material according to claim 11, wherein an optical transmittance in the visible region is 50% or more.
